(19) United States
(12) Patent Application Publication
(10) Pub. No.: US 2005/0024011 A1
(43) Pub. Date: Feb. 3, 2005

(54) Charger for cellular phone

(75) Inventor: Yu-Sheng Chen, Taipei Hsien (TW)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei Hsien (TW)

(21) Appl. No.: 10/627,811

(22) Filed: Jul. 28, 2003

(51) Int. Cl. H02J 7/00

(52) U.S. Cl. 320/107

(57) ABSTRACT

The present invention is to provide a charger for cellular phone comprising a body having a well and a battery compartment on its opposite surfaces, at least one pair of positive and negative terminals in the battery compartment, at least one pair of electrical contacts on the well and a charging circuit inside the body being electrically coupled to and the electrical contacts and terminals respectively. When the cellular phone is rested on the well, charging plugs of the cellular phone are electrically coupled to the electrical contacts. Thus, the charging circuit is adapted to automatically supply power from either the external power source or the cells (or batterys) received in the battery compartment to charge at least one electrical energy storage element in the cellular phone.

### FIELD OF THE INVENTION

The present invention relates to chargers and more particularly to a charger for cellular phone with improved characteristics.

### BACKGROUND OF THE INVENTION

Recently, various types of electronic and communication products are manufactured in a mass production due to the fast progress in electronics and technology. Also, such products are widely employed in our daily life. For example, cellular phones have advantages of being compact, portable, and mobile. Hence, we can say that almost every one owns a cellular phone in many countries. There is no doubt that cellular phones have changed our life style since its birth. Further, cellular phones can bring much convenience to our daily life.

A typical charger for a cellular phone in general comprises a body, a well formed on one surface of the body, a pair of electrical contacts in the well, a battery compartment on the opposite other surface of the body, at least one pair of positive and negative terminals in the battery compartment, and a charging circuit inside the body. The charging circuit is electrically coupled to the electrical contacts and the positive and negative terminals respectively. Charging plugs of a cellular phone are electrically coupled to the electrical contacts when the cellular phone is rested on the well. A connector of the body is electrically coupled to a power adapter which is in turn electrically coupled to an external power source (e.g., AC (alternating current) fed from a power company). The power adapter is adapted to convert AC from the external power source into DC (direct current) having a voltage value equal to that required by the cellular phone. DC is then applied to an electrical energy storage element of the cellular phone for charging via the positive and negative terminals and the charging plugs.

The above charger is adapted to charge the electrical energy storage element of the cellular phone for maintaining its normal operation. The cellular phone, however, cannot be charged by the charger when the cellular phone is carried by a user who is on a railroad carriage, plane, or outdoors. This is because there is no power outlet of external power source available for connecting the charger thereto. Moreover, it is impossible of charging a cellular phone via the charger when the cellular phone is carried by a user who travels to another country implementing a regulated voltage different from that of his/her own country (i.e., 110 VAC versus 220 VAC). Thus, the need for improvement still exists.

### SUMMARY OF THE INVENTION

A primary object of the present invention is to provide a novel charger adapted to charge a cellular phone for enabling the widely employed cellular phones to bring more convenience to our daily life. By utilizing the present invention, the above drawbacks of the prior art can be overcome. These drawbacks are that a cellular phone cannot be charged by a prior charger when the cellular phone is carried by a user who is on a railroad carriage, plane, or outdoors due to no power outlet of external power source available for connection. Moreover, it is impossible of charging a cellular phone via the prior charger when the cellular phone is carried by a user who travels to another country implementing a regulated voltage different from that of his/her own country.

One object of the present invention is to provide a charger capable of electrically coupling to an external power source. Also, at least one pair of cells (or batterys) is mounted in the charger. In one case the charger is adapted to transmit power from the external power source to charge the cellular phone. In another case the charger is adapted to transmit power from the cells to charge the cellular phone when the external power source is not available. The charger includes a body comprising opposite well and battery compartment on its surfaces, at least one pair of positive and negative terminals in the battery compartment, a charging circuit inside the body, the charging circuit being electrically coupled to the electrical contacts and at least one pair of the positive and negative terminals respectively. Charging plugs of the cellular phone are electrically coupled to the electrical contacts when the cellular phone is rested on the well. Thus, the charging circuit is adapted to automatically supply power from either the external power source or the cells to charge at least one electrical energy storage element in the cellular phone.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of charger according to the invention, the charger being shown to couple to a cellular phone;

FIG. 2 is another perspective view of the charger with cover of the battery compartment open to show cells mounted therein; and

FIG. 3 is a block diagram showing electrical components of the charger and the cellular phone and the external power source.

### DETAILED DESCRIPTION OF THE PREFERRED EMBODIMENTS

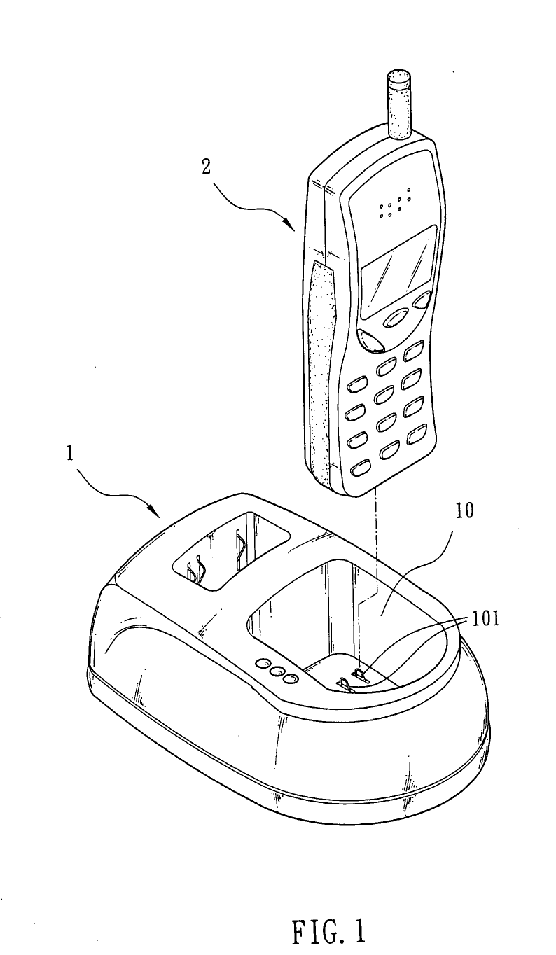

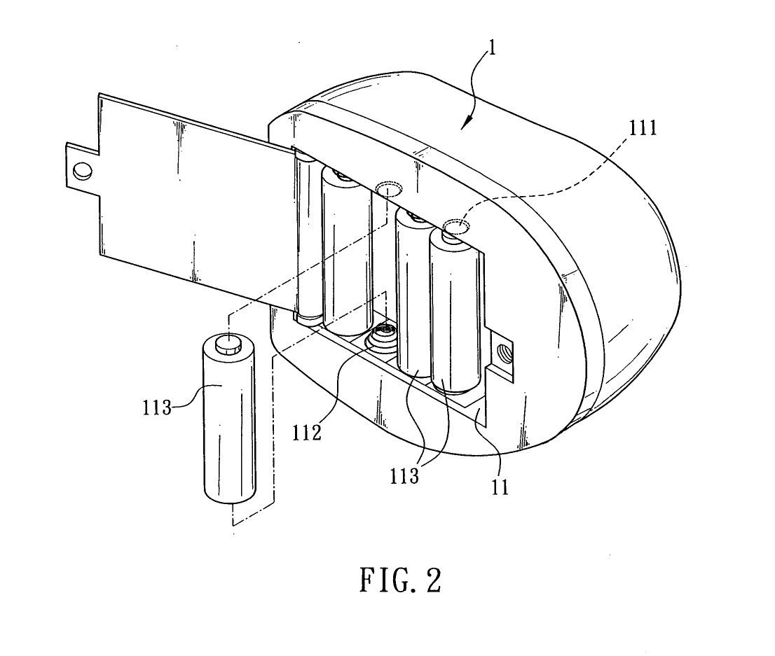

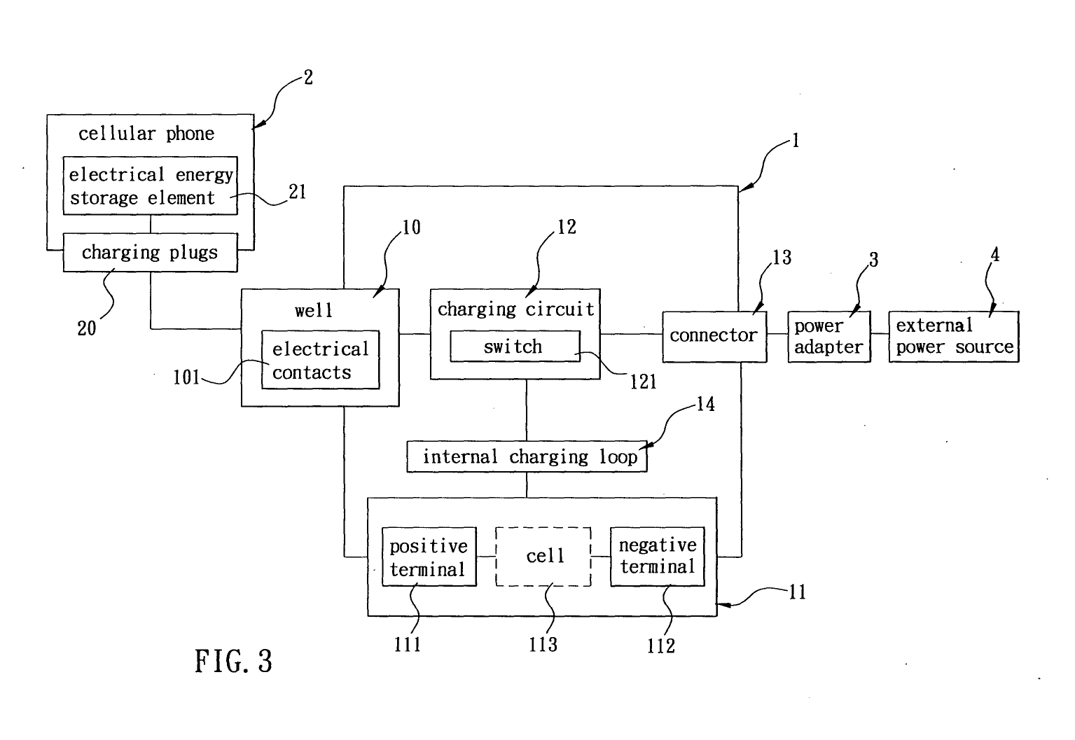

Referring to FIGS. 1, 2, and 3, a charger for cellular phone in accordance with the invention is shown. The charger comprises a body 1, a well 10 formed on one surface of the body 1, a pair of electrical contacts 101 in the well 10 (see FIG. 1), a battery compartment 11 on the opposite other surface of the body 1, and at least one pair (two pairs are shown) of positive and negative terminals 111, 112 in the battery compartment 11 with four cells (e.g., alkalic cells or batterys) 113 received in the battery compartment 11 to form an electrical connection. The charger further comprises a charging circuit 12 inside the body 1 (see FIG. 3). The charging circuit is electrically coupled to the electrical contacts 101, the pairs of the positive and negative terminals 111, 112, and a connector 13 having one end exposed on the body 1 respectively. Charging plugs 20 of a cellular phone 2 are electrically coupled to the electrical contacts 101 when the cellular phone 2 is rested on the well 10. The connector 13 is adapted to transmit power from either an external power source 4 or the cells 113 to the charging circuit 12 for charging at least one electrical energy storage element 21 (e.g., lithium or hydrogen-nickel cell or battery) in the cellular phone 2.

Referring to FIGS. 1, 2, and 3 again, in the invention two techniques are employed to charge the electrical energy storage element 21 by the charging circuit 12 as detailed below.

First one is characterized in that the connector 13 is electrically coupled to a power adapter 3 which is in turn electrically coupled to the external power source (e.g., AC supplied from a power company) 4. The charging circuit 12 is adapted to convert AC from the external power source 4 into DC having a voltage value equal to that required by the electrical energy storage element 21. DC is then applied to the electrical energy storage element 21 for charging via the electrical contacts 101 and the charging plugs 20.

Second one is characterized in that the cells 113 are received in the battery compartment 11 to form an electrical connection with the pairs of positive and negative terminals 111, 112. As such, the charging circuit 12 is adapted to lower or raise DC supplied from the cells 113 prior to supplying it to the electrical energy storage element 21 for charging in which the DC supplied to the electrical energy storage element 21 has a voltage value equal to that required by the electrical energy storage element 21.

Referring to FIGS. 1, 2, and 3 again, in the invention the charging circuit 12 comprises a switch 121. In response to coupling to the power adapter 3, the charging circuit 12 is adapted to convert AC from the external power source 4 into DC having a voltage value equal to that required by the electrical energy storage element 21. DC is then applied to the electrical energy storage element 21 for charging via the electrical contacts 101 and the charging plugs 20. In a case that the connector 13 is not coupled to the power adapter 3 or the power adapter 3 is not coupled to the external power source 4, the switch 121 is switched automatically to supply DC from the cells 113 to the electrical energy storage element 21 for charging via the electrical contacts 101 and the charging plugs 20.

Moreover, an internal charging loop 14 is provided between the charging circuit 12 and the battery compartment 11. The cells 113 in the battery compartment 11 are implemented as rechargeable batteries in one embodiment. As such the charging circuit 12 not only can charge the electrical energy storage element 21 by means of power supplied from the external power source 4 but also can charge the rechargeable batteries via the internal charging loop 14 at the same time. The switch 121 is switched automatically to supply DC from the rechargeable batteries to the electrical energy storage element 21 for charging via the electrical contacts 101 and the charging plugs 20 when the connector 13 is not coupled to the power adapter 3 or the power adapter 3 is not coupled to the external power source 4.

While the invention has been described by means of specific embodiments, numerous modifications and variations could be made thereto by those skilled in the art without departing from the scope and spirit of the invention set forth in the claims.

1. A charger for a cellular phone, the charger including a body comprising:
a well on one surface of the body for enabling a cellular phone to rest thereon;
at least a pair of electrical contacts in the well for electrically connecting with the cellular phone;
a battery compartment on the opposite other surface of the body for receiving a plurality of cells;
at least one pair of positive and negative terminals in the battery compartment for electrically connecting with the cells;
a connector having one end exposed on the body for electrically connecting with an external power source; and
a charging circuit inside the body, the charging circuit being electrically coupled to the electrical contacts, the positive and negative terminals, and the other end of the connector respectively for supplying power from either the external power source or the cells to charge at least one electrical energy storage element in the cellular phone.

2. The charger of claim 1, wherein the charging circuit comprises a switch for switching the power charging the cellular phone from either the external power source or the cells.

3. The charger of claim 1, further comprising an internal charging loop between the charging circuit and the terminals, enabling the charging circuit to supply power from the external power source to charge the cells.
